(19) United States
(12) Patent Application Publication
(10) Pub. No.: US 2015/0229715 A1
(43) Pub. Date: Aug. 13, 2015

(54) CLUSTER MANAGEMENT

(71) Applicant: LinkedIn Corporation, Mountain View, CA (US)

(72) Inventors: Sriram Sankar, Palo Alto, CA (US); Diego Buthay, San Francisco, CA (US)

(21) Appl. No.: 14/587,771

(22) Filed: Dec. 31, 2014

Related U.S. Application Data
(60) Provisional application No. 61/939,429, filed on Feb. 13, 2014.

(51) Int. Cl. H04L 29/08; H04L 12/24

(52) U.S. Cl. CPC H04L 67/1031; H04L 41/0893

(57) ABSTRACT

Methods and systems cluster management are disclosed. In some example embodiments, a cluster manager determines a configuration of roles for a plurality of distinct server machines and for a plurality of builder machines, with each one of the server machines storing a corresponding shard of data, and each one of the plurality of builder machines comprising a corresponding one of the corresponding shards of data of the server machines. The cluster manager applies the configuration of roles to the plurality of server machines, the plurality of builder machines, and an aggregator, with the configuration of the builder machines being characterized by an absence of communication with the aggregator. The configuration is used to determine which machines to be communicated with by the aggregator for a client request and which machines to be communicated with by an update service for an update of data.

### CROSS-REFERENCE TO RELATED APPLICATIONS

This application claims priority to U.S. Provisional Application No. 61/939,429, filed on Feb. 13, 2014, entitled, “SEARCH INFRASTRUCTURE”, which is hereby incorporated by reference in its entirety as if set forth herein.

### TECHNICAL FIELD

The present application relates generally to data processing systems and, in one specific example, to systems and methods for cluster management.

### BACKGROUND

Search indices typically occupy a large amount of memory of the machines in which they reside. Updating these indices is important, particularly in the context of social networking websites, where documents are continuously changing as a result of social networking operations performed by users, such as adding connections and other content changes. Performing these updates can be computationally expensive and have the potential to negatively affect the seamless operation of the website.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 is a block diagram illustrating a client-server system, in accordance with some example embodiments;

FIG. 2 is a block diagram showing the functional components of a social network service within a networked system, in accordance with some example embodiments;

FIG. 3 illustrates a three-layered incremental index update, in accordance with some example embodiments;

FIG. 4 illustrates elements of a cluster management system, in accordance with some example embodiments;

FIGS. 5A-5B illustrates replica groups, in accordance with some example embodiments;

FIG. 6 is a flowchart illustrating a method of cluster management, in accordance with some example embodiments;

FIG. 7 is a flowchart illustrating another method of cluster management, in accordance with some example embodiments;

FIG. 8 is a flowchart illustrating a yet another method of cluster management, in accordance with some example embodiments; and

FIG. 9 is a block diagram of an example computer system on which methodologies described herein may be executed, in accordance with some example embodiments.

### DETAILED DESCRIPTION

Example systems and methods of cluster management are described. In the following description, for purposes of explanation, numerous specific details are set forth in order to provide a thorough understanding of example embodiments. It will be evident, however, to one skilled in the art that the present embodiments may be practiced without these specific details.

The features of the present disclosure provide cluster management techniques that improve the functioning of computer systems. These features are particularly useful in the area of search, although they can also be employed in other environments and scenarios. In the some example embodiments, a computer system can comprise a set of machines that can be used for multiple indexes. Different nodes of the computer system can have different roles or functions. For example, the computer system can comprise indexer nodes as well as broker nodes. A cluster manager can decide, given the number of indexes, which are the best servers to allocate to each of the roles for that index. The cluster manager can do this in a multi-tenant fashion, such that a given server can host resources or roles for different indexes. The computer system, via the cluster manager, can also be self-healing, meaning that it can detect when a given index is under-provisioned due to a server machine dying or a server being overloaded. The cluster manager can select another server machine on the cluster and assign it the same role as the failed server machine in order to expand the capacity of that role for that particular index. At the same time, the cluster manager can make such selections and allocations without violating any predetermined constraints (e.g., do not host all data for a given index on only a single server machine, because if there is a power outage on that particular server machine, then the computer system will not be able to serve traffic for that role). The cluster manager can maintain constraints about what resources can be co-located with other resources in an attempt to maximize the uptime of the cluster.

In some example embodiments, a cluster manager determines a configuration of roles for a plurality of distinct server machines and for a plurality of builder machines, with each one of the server machines storing a corresponding shard of data, and each one of the plurality of builder machines comprising a corresponding one of the corresponding shards of data of the server machines. The cluster manager applies the configuration of roles to the plurality of server machines, the plurality of builder machines, and an aggregator, with the configuration of the builder machines being characterized by an absence of communication with the aggregator. The aggregator receives a client request to perform an online service, and then transmits a service request to each one of the plurality of server machines based on the client request. Each one of the server machines receives the service request, with each one of the server machines storing a corresponding shard of data. Each one of the server machines accesses the corresponding shard of data, and transmits a corresponding response to the aggregator based on the accessed corresponding shard of data. An update service receives update data. The update service updates the corresponding shard of data of at least one of the server machines based on the update data and the configuration of roles, and updates the corresponding shard of data of at least one of the builder machines based on the update data and the configuration of roles.

In some example embodiments, the cluster manager manages a plurality of replica groups, with each replica group comprising a corresponding one of the server machines and at least one replica machine. The replica machine(s) comprise the corresponding shard of data of the corresponding server machine of the corresponding replica group. Managing the replica groups comprises, in response to an update of the corresponding shard of one of the server machines, causing the update service to perform a corresponding update to the replica machine(s) in the corresponding replica group of the one of the server machines.

In some example embodiments, an aggregator receives a client request to perform an online service. The aggregator transmits a service request to each one of a plurality of distinct server machines based on the client request. Each one of the server machines stores a corresponding shard of data, and receives the service request. Each one of the server machines accesses the corresponding shard of data, and transmits a corresponding response to the aggregator based on the accessing of the corresponding shard of data. A cluster manager receives update data, and updates the corresponding shard of data of at least one of the server machines based on the update data. The cluster manager determines, from amongst a plurality of build machines, at least one builder machine to update. Each one of the plurality of builder machines comprises a corresponding one of the corresponding shards of data of the server machines, and the builder machines are characterized by an absence of communication with the aggregator. The cluster manager updates the corresponding shard of data of the determined builder machine based on the update data.

In some example embodiments, the cluster manager manages a plurality of replica groups, with each replica group comprising a corresponding one of the server machines and at least one replica machine. The replica machine(s) comprise the corresponding shard of data of the corresponding server machine of the corresponding replica group. Managing the replica groups comprises, in response to an update of the corresponding shard of one of the server machines, performing a corresponding update to the replica machine(s) in the corresponding replica group of the one of the server machines.

In some example embodiments, the cluster manager detects one of the server machines that is unable to satisfy a predetermined threshold condition of a function, selects a replacement server from amongst a plurality of replacement servers based on a determination that the selected replacement server satisfies at least one predetermined constraint, and replaces the detected server machine with the selected replacement machine.

In some example embodiments, the online service comprises a search function. In some example embodiments, the shards of data of the server machines comprise ranking model files of a search index. In some example embodiments, the shards of data of the server machines comprise language model files for a query rewriter. In some example embodiments, the server machines are incorporated into an online social networking service.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

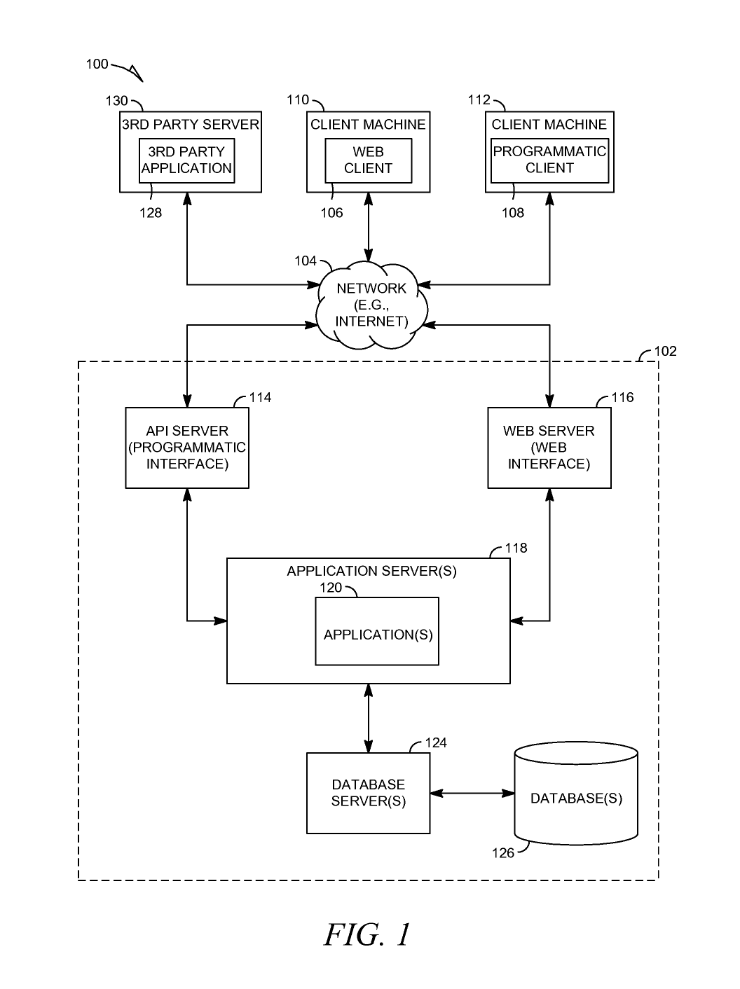

FIG. 1 is a block diagram illustrating a client-server system, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

In some embodiments, any website referred to herein may comprise online content that may be rendered on a variety of devices, including but not limited to, a desktop personal computer, a laptop, and a mobile device (e.g., a tablet computer, smartphone, etc.). In this respect, the any of these devices may be employed by a user to use the features of the present disclosure. In some embodiments, a user can use a mobile app on a mobile device (any of machines 110, 112, and 130 may be a mobile device) to access and browse online content, such as any of the online content disclosed herein. A mobile server (e.g., API server 114) may communicate with the mobile app and the application server(s) 118 in order to make the features of the present disclosure available on the mobile device.

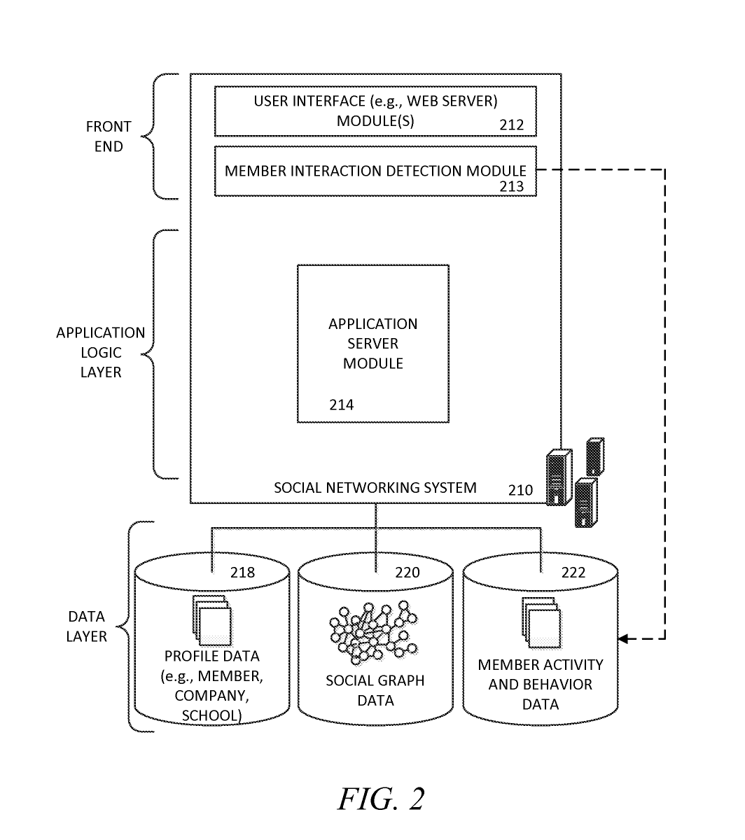

In some embodiments, the networked system 102 may comprise functional components of a social network service. FIG. 2 is a block diagram showing the functional components of a social networking service, consistent with some embodiments of the present disclosure. As shown in FIG. 2, a front end may comprise a user interface module (e.g., a web server) 212, which receives requests from various client-computing devices, and communicates appropriate responses to the requesting client devices. For example, the user interface module(s) 212 may receive requests in the form of Hypertext Transport Protocol (HTTP) requests, or other web-based, application programming interface (API) requests. In addition, a member interaction and detection module 213 may be provided to detect various interactions that members have with different applications, services and content presented. As shown in FIG. 2, upon detecting a particular interaction, the detection module 213 logs the interaction, including the type of interaction and any meta-data relating to the interaction, in the activity and behavior database with reference number 222.

An application logic layer may include one or more various application server modules 214, which, in conjunction with the user interface module(s) 212, generate various user interfaces (e.g., web pages) with data retrieved from various data sources in the data layer. With some embodiments, individual application server modules 214 are used to implement the functionality associated with various applications and/or services provided by the social networking service.

As shown in FIG. 2, a data layer may includes several databases, such as a database 218 for storing profile data, including both member profile data as well as profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database with reference number 218. Similarly, when a representative of an organization initially registers the organization with the social networking service, the representative may be prompted to provide certain information about the organization. This information may be stored, for example, in the database with reference number 218, or another database (not shown). With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social networking service. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates (e.g., in an activity or content stream) or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream. In any case, the various associations and relationships that the members establish with other members, or with other entities and objects, are stored and maintained within a social graph, shown in FIG. 2 with reference number 220.

As members interact with the various applications, services and content made available via the social networking service, the members' interactions and behavior (e.g., content viewed, links or buttons selected, messages responded to, etc.) may be tracked and information concerning the member's activities and behavior may be logged or stored, for example, as indicated in FIG. 2 by the database with reference number 222. In some embodiments, databases 218, 220, and 222 may be incorporated into database(s) 126 in FIG. 1. However, other configurations are also within the scope of the present disclosure.

Although some features of the present disclosure are presented in the context of a social networking system, it is contemplated that the features disclosed herein are applicable to other system, environments, and embodiments as well.

Search engines deal with large amounts of documents. These documents can comprises a variety of different content, including, but not limited to, members of a social network service (e.g., LinkedIn® members) or web documents (e.g., search result documents on Google®). This set of documents makes up the search corpus. Each of these documents has pieces of text or other attributes on which the search engine can search. When a user performs a search on words, those words match a large number of documents, and the words together are constrained to match fewer documents, but still a large number of documents. The search engine determines the best match and returns it as a search result. In order to determine which documents match a search query, you can build a data structure called an index can be built in memory.

Indexes typically occupy most of the memory of the machine in which they reside. However, the documents keep changing, especially with social networking websites where all of the documents need to be up to date. For example, if a member changes their content (e.g., adds a connection, makes certain content private), all of those changes are important. An index can be built offline. However, an approach can be used to update it incrementally, so that it stays completely fresh up-to-date.

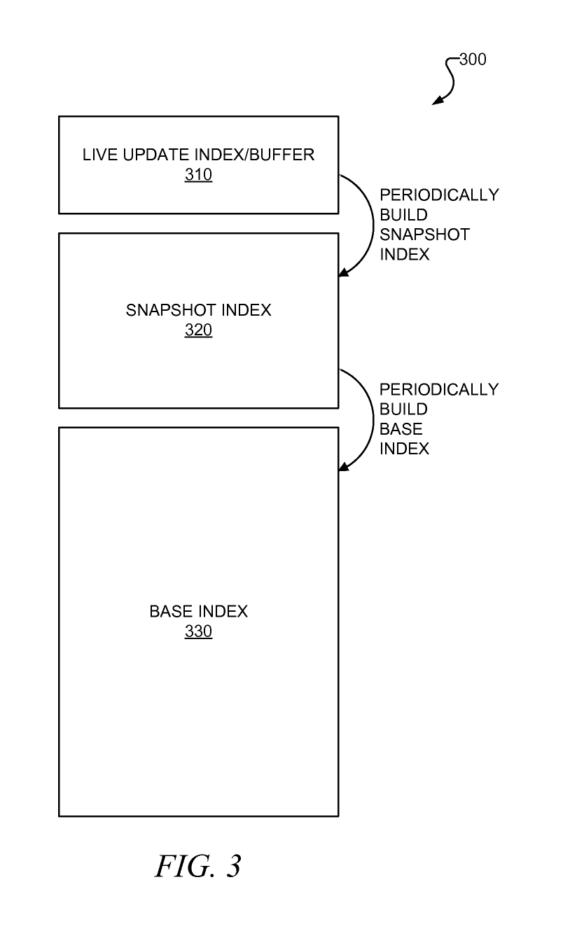

FIG. 3 illustrates a three-layered incremental index update 300, in accordance with some example embodiments. The update 300 can involve a live update index or buffer 310 in a random-access memory (RAM), a snapshot index 320 on a disk storage, and a base index 330 also on a disk storage. The base index 330 can comprise a large index (e.g., a multi-gigabyte index) that can be built offline on a software framework for distributed storage and distributed processing of big data on clusters of commodity hardware. The live update index/buffer 310 can be implemented as a data structure that stores all recent updates in memory and allows them to be searched efficiently. The snapshot index 320 can be implemented as an index that is periodically (e.g., every few hours) built from the live update index/buffer 310, at which point the live update buffer 310 can be cleared.

In some example embodiments, as part of the three-layered incremental index update 300, any changes to content corresponding to the base index 330 are first saved to the live update index/buffer 310. Periodically, after a first predetermined amount of time (e.g., every 3 hours), the contents of the live update index/buffer 310 are saved to disk, creating a snapshot (also referred to as “snapshotting”). Similarly, periodically, after a second predetermined amount of time that is larger than the first predetermined amount of time (e.g., once a week), the base index 330 is built using the data from the snapshot index 320. The live update index/buffer 310 can be merged with the snapshot index 320, and the snapshot index 320 can subsequently be merged with the based index 330. In some example embodiments, the live update index/buffer 310 and the snapshot index 320 are relatively small compared to the base index 330, so that they do not have to be particularly efficient with the use of memory or in their use of time, but rather can be more volatile as storage mechanisms, while the base index 330 can be treated as a persistent structure.

At any given time, a system can comprise the base index 330, as well as the snapshot index 320, which represents the changes over a period of time since the base index 330 was built. The system also comprises the live update index/buffer 310, which comprises the most recent changes since the last update of the snapshot index 320. This three-layered incremental index update 300 provides an efficient and reliable system for maintaining and updating an index.

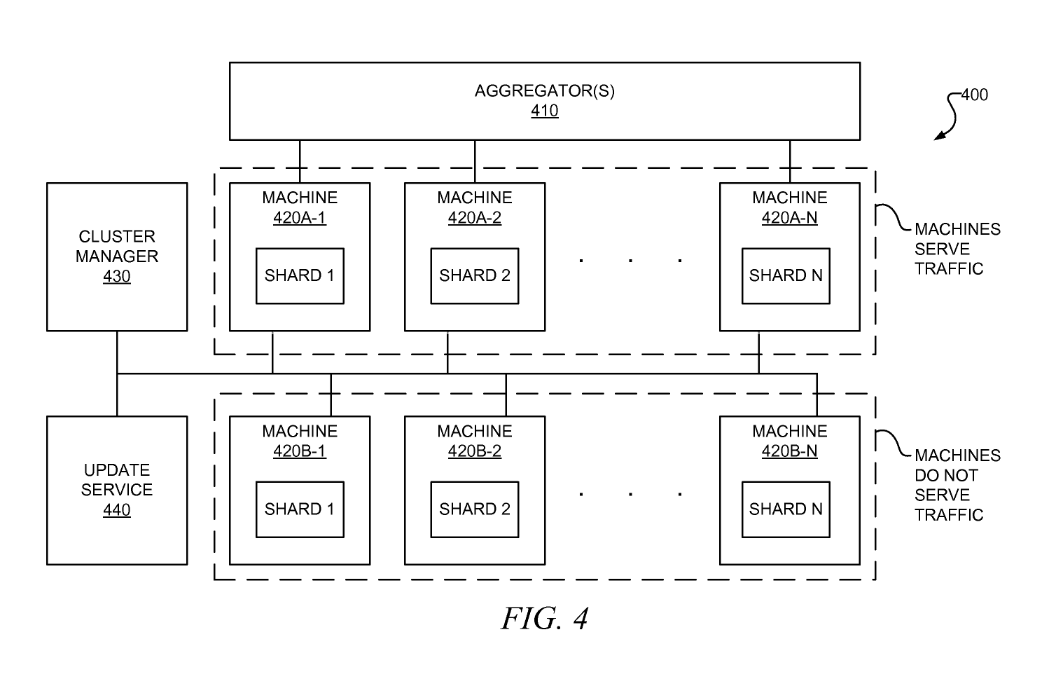

FIG. 4 illustrates elements of a cluster management system 400, in accordance with some example embodiments. In some example embodiments, sharding of an index is employed, dividing the index into multiple partitions and maintaining these partitions on different machines. In FIG. 4, the cluster management system 400 comprises a plurality of server machines 420A (e.g., 420A-1, 420A-2, . . . , 420A-N). An index can be partitioned into N shards, such as shard 1, shard 2, . . . , shard N, which can each be stored on a corresponding server machine 420A. Although FIG. 4 shows only one shard in each of the server machines 420A, it is contemplated that a multi-tenant configuration can be implemented, with multiple shards on each server machine 420A.

An aggregator 410 using a scatter-gather framework can receive a client request, such as a search query, and transmit a corresponding service request to the shards 1 to N on the server machines 420A. Each server machine 420A can execute the service request, such as by accessing its corresponding shard to determine if it comprises any content corresponding to the service request, and then transmit a corresponding response to the aggregator based on the access of the corresponding shard. The aggregator 410 can receive the responses from each of the shards 1 to N, combine them into an aggregated response, which can then be transmitted to the client that submitted the client request. An online service. Such as a social networking service, can comprise multiple sets of aggregators 410 and pluralities of server machines 420A. Additionally, multiple aggregators 410 can communicate requests to the same set of shards. Accordingly, an appropriate corresponding topology can be configured based on traffic.

The three-layered index approach of FIG. 3 can be implemented in the cluster management system 400 of FIG. 4, with the indexes being partitioned and maintained on the server machines 420A. However, building a snapshot can be computationally expensive, and can be too expensive to be performed by a server machine 420A that is also serving traffic such as search queries.

In some example embodiments, a separate set of machines whose only job is to build indexes (e.g., the snapshot indexes 320 of FIG. 3) can be employed. Accordingly, the cluster management system 400 can comprise a plurality of builder machines 420B (e.g., 420B-1, 420B-2, . . . , 420B-N). These builder machines 420B can be configured to mirror the server machines 420A in terms of the content stored on them. However, in contrast to the server machines 420A, the builder machines 420B do not serve traffic, including any traffic from the aggregator(s) 410. Since the builder machines 420B do not have an aggregator 410 communicating with them, they do not have any search traffic coming to them, but can otherwise be completely equal to the server machines 420A. The builder machines 420B, like the server machines 420A, can also receive updates of their respective shards of data, such as shards of an index. In some example embodiments, the only job of the builder machines 420B is to maintain the indexes, such as by periodically (e.g., every couple of hours) taking any updates from the live update index/buffer 310 and merging them into the snapshot index 320, and/or performing any of the other operations of the three-layered incremental index update 300 of FIG. 3.

In some example embodiments, the cluster management system 400 comprises a cluster manager 430 to manage the operations discussed herein, as well as the configuration of the aggregator(s) 410, the server machines 420A, and the builder machines 420B.

The cluster manager 430 can also offer a solution to replicate files (e.g., from single or multiple sources) to multiple destinations (e.g., either fixed or changing destinations). Some examples of such replication can include, but are not limited to, replication of search index shards from a single source to all replicas of that shard that are serving production traffic. In some example embodiments, the cluster manager 430 is configured to create and manage replica groups. A replica group can comprise a group of services (which can run on separate machine) that share a set of files. Some example of replica groups include, but are not limited to, search nodes that serve a specific shard of a search index, broker nodes that share language model files that are used for query rewriting, and search nodes across all shards that share ranking model files. In some example embodiments, a service can be a member of multiple replica groups.

Each replica group can have a distinct name that identifies it. Members (e.g., services) of a replica group can add files or directories to the replica group. These files/directories can already be present on the machine running the service. The result of performing this operation is that the files/directories are eventually replicated to all of the other members of the replica group. In some example embodiments, adding a file/directory to a replica group comprises the following steps:
a) build a group torrent file for the file/directory and store it in the group_torrents directory of the replica group;
b) build the meta torrent file for the group torrent file and add it to the cluster manager 430;
c) notify other concrete instances of this replica group that a new meta torrent file is available;
d) each of the other concrete instances obtains the new meta torrent file and uses it to get a copy of the group torrent file; and
e) each of these other concrete instances then uses the group torrent file to get a copy of the actual file/directory.

In some example, in response to one of the machines 420A or 420B generating a snapshot, the machine 420A or 420B (or the cluster manager 430) marks the snapshot as part of its corresponding group, and the other machines 420A and/or 420B in that group get the data from the snapshot automatically.

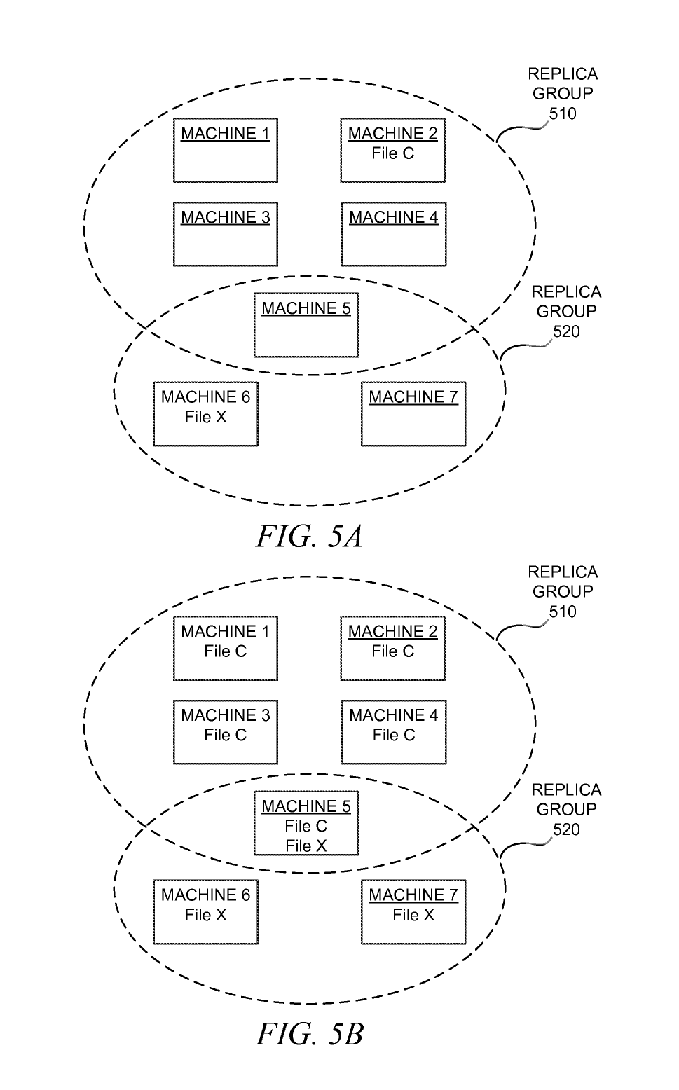

FIGS. 5A-5B illustrate replica groups 510 and 520, in accordance with some example embodiments. Although FIGS. 5A-5B only show two replica groups 510 and 520, it is contemplated that any number of replica groups can be employed. The cluster manager 430 can take machines 420A and 420B in its network, and group them together into logical units (as part of the cluster management system 400). The cluster manager 430 can dump a file into a particular machine 420A or 420B and mark it as part of the corresponding replica group. As a result, the cluster manager 430 can automatically copy the file to every other machine 420A and/or 520B in the same replica group. For example, in FIG. 5A, Machines 1-4 are part of replica group 510 (e.g., Cluster A), while Machines 6-7 are part of replica group 520 (e.g., Cluster B). Machine 5 is part of both replica group 510 and replica group 520. In FIG. 5A, if File C is dumped into Machine 2, it can then be copied into all of the other machines (Machines 1, 3, 4, and 5) in the same replica group 510, as seen in FIG. 5B. Similarly, in FIG. 5A, if File X is dumped into Machine 6, it can then be copied into all of the other machines (Machines 5 and 7) in the same replica group 520, as seen in FIG. 5B. Therefore, as an index is built, if a file is dumped into any machine of a replica group, the cluster manager 430 can automatically distribute the file into all of the other machines in that same replica group.

In some example embodiments, the cluster manager 430 receives update data and performs the update of the appropriate machine(s), while in other example embodiments, an update service 440 (shown in FIG. 4) receives update data and performs the update of the appropriate machine(s) based on the configuration of roles or replica groups of the machine(s) determined by the cluster manager 430. Accordingly, any of the update operations discussed herein as being performed by the cluster manager 430 can alternatively be performed by the update service 440 based on a configuration of roles and/or replica groups determined by the cluster manager 430.

In some example embodiments, there can be many different instances serving different indexes, each with their own set of replica groups. The cluster manager 430 can construct the replica groups, automate the index building process, and specify the kind of traffic that is transmitted to the machines of the replica groups. The cluster manager 430 can automatically determine that a certain number of machines has been set aside for a certain purpose/function and a certain number of machines for another purpose/function, and so on. If one day a particular machine has a hardware error and fails, the cluster manager 430 can automatically replace the failed machine with a replacement machine. If there is no spare machine to use as a replacement, then the cluster manager 430 can determine which of the already existing replica machines are the least loaded, and can uses that as a replacement. If several new machines are introduced, the cluster manager 430 can determine which machines are the busiest and can replicate them. The cluster manager 430 can perform an automation process to analyse and determine the topology of the replica groups and then insert the replacement machine into the appropriate replica group(s) based on the analysis, resulting in the files being automatically distributed to each machine in the corresponding replica group(s).

Different replica groups can have different configurations, and different replica machines within the same replica group can have different configurations. Given a set of nodes, the cluster manager 430 can decide how many of each of type of resource the overall system should have and where each resource should be located. For example, the cluster manager 430 can determine that it is convenient for all the server machines in a given replica group to be disposed on the same rack because they are going to be sharing files over the network, and therefore allocate the server machines accordingly. Additionally, the cluster manager 430 can be configured to determine that the system needs to serve more traffic, might have hardware failures, might have a network partition, or other conditions that might need to be remedied. Accordingly, the cluster manager 430 can be configured to determine that some of the constraints of the system have changed or are being violated and attempt to achieve the ideal configuration by performing self-healing operations. For example, the cluster manager 430 can change the roles that each of the machines 420A and/or 420B are playing on the cluster in order to achieve that ideal state, thus providing a self-healing aspect.

The cluster manager 430 can employ an atomic swap to update the server machines 420A. The cluster manager 430 is configured to control data flow for the indexes (e.g., stopping traffic, moving traffic), as well as resource flow for capacity.

The cluster manager 430 can also handle software upgrades. In an example where a replica group for search comprises five server machines for search, a software upgrade can be performed on the server machines. The cluster manager 430 can shut down the server machines, install the new software, and then bring the server machines back up. Since the server machines are shut down, it has the effect of a planned power failure. One thing that the cluster manager 430 can do to remedy the situation is to allocate a sixth server machine, and insert the sixth server machine into the same replica group as the other five server machines so that it receives a replica of the same files stored in the five other server machines right away. As a result, there is new sixth server machine with the same role as the original group of five server machines. The cluster manager 430 can then start removing the five server machines from serving the aggregator(s) 410, one at a time, and using the addition of the new server machine to temporarily replace the removed server machine as the removed server machine is updated with the software upgrade. The removed server machine can then be placed back into production serving the aggregator(s) 410 after it is upgraded, and the cluster manager 430 can then perform the same removal, replacement, and upgrade process for the next server machine in the replica group, and so on and so forth until all of the server machines in the replica group are upgraded. It is contemplated that this upgrade process can be applied to clusters of machines, shutting-down or removing an entire cluster of machines at the same time and grading them at the same time while they are temporarily replaced by the new additional set of machines.

The upgrade feature of the cluster manager 430 enables the system to provide a desired minimum number of server machines at any given time, even during an upgrade. The cluster manager 430 can replicate the server machines so that when they are shut down, the system has server machines serving the same roes of the shut-down server machines, so that the server machines can be safely shut down without violating the constraints of the system, such as how much capacity is required at any given point in time.

As previously mentioned, the cluster manager 430 can also allocate resources, such as server machines, to certain roles in a system. Some considerations for the allocation of resources to roles can include, but are not limited to, location, memory size, and CPU power of the server.

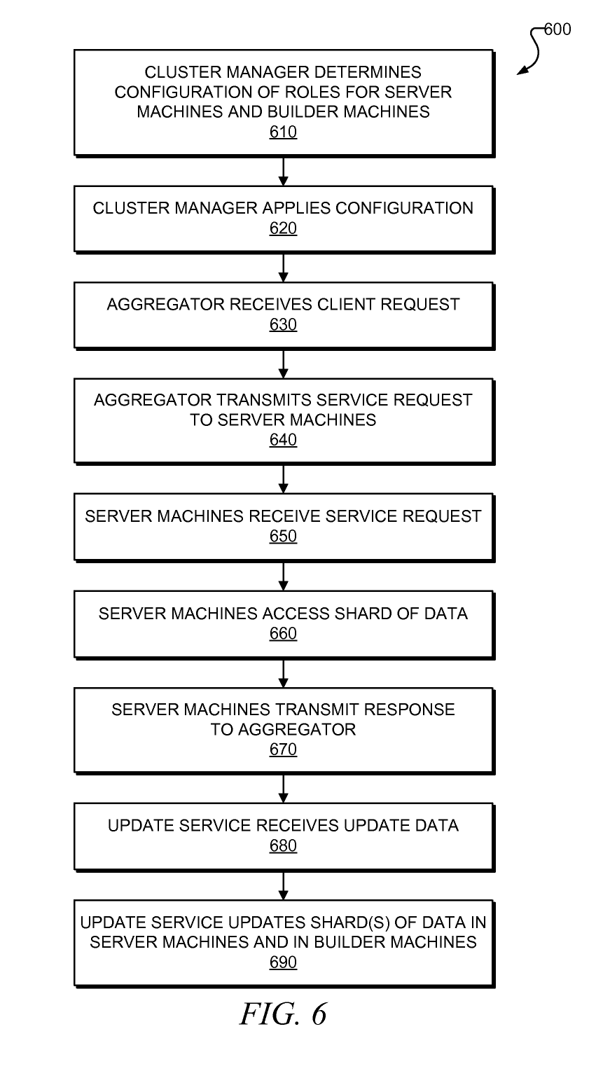

FIG. 6 is a flowchart illustrating a method 600 of cluster management, in accordance with some example embodiments. Method 600 can be performed by processing logic that can comprise hardware (e.g., circuitry, dedicated logic, programmable logic, microcode, etc.), software (e.g., instructions run on a processing device), or a combination thereof. In one implementation, the method 600 is performed by the cluster management system 300 of FIG. 3, or any combination of one or more of its components, as described above.

At operation 610, a cluster manager determines a configuration of roles for a plurality of distinct server machines and for a plurality of builder machines, with each one of the server machines storing a corresponding shard of data, and each one of the plurality of builder machines comprising a corresponding one of the corresponding shards of data of the server machines. At operation 620, the cluster manager applies the configuration of roles to the plurality of server machines, the plurality of builder machines, and an aggregator, with the configuration of the builder machines being characterized by an absence of communication with the aggregator. At operation 630, the aggregator receives a client request to perform an online service. At operation 640, the aggregator transmits a service request to each one of the plurality of server machines based on the client request. At operation 650, each one of the server machines receives the service request, with each one of the server machines storing a corresponding shard of data. At operation 660, each one of the server machines accesses the corresponding shard of data. At operation 670, each one of the server machines transmits a corresponding response to the aggregator based on the accessing the corresponding shard of data. At operation 680, an update service receives update data. At operation 690, the update service updates the corresponding shard of data of at least one of the server machines based on the update data and the configuration of roles, and updates the corresponding shard of data of at least one of the builder machines based on the update data and the configuration of roles.

It is contemplated that any of the other features described within the present disclosure can be incorporated into method 600.

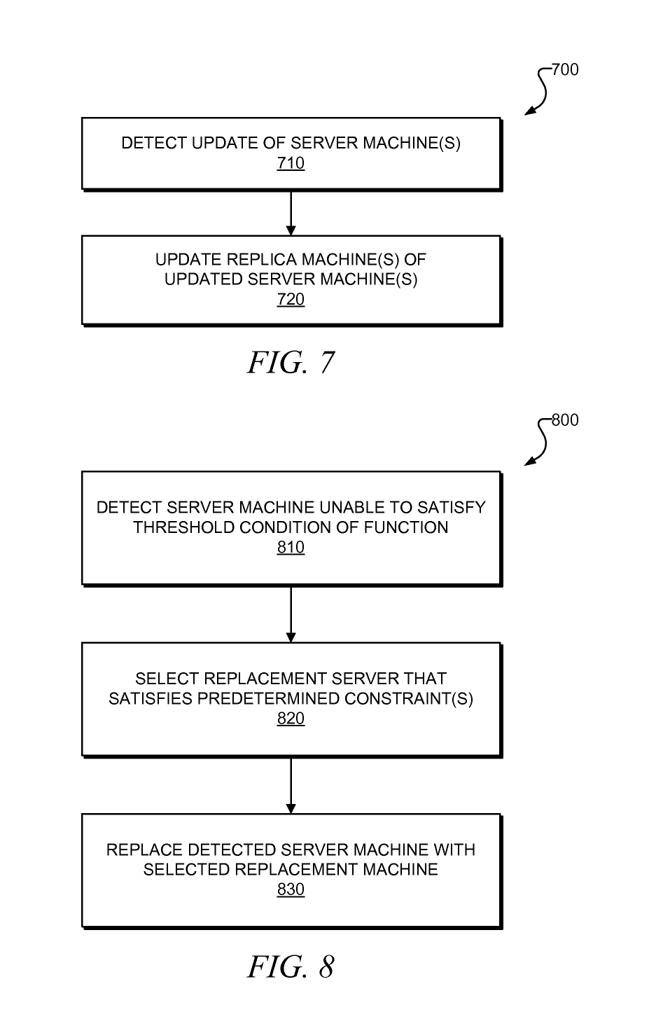

FIG. 7 is a flowchart illustrating a method 700 of cluster management, in accordance with some example embodiments. Method 700 can be performed by processing logic that can comprise hardware (e.g., circuitry, dedicated logic, programmable logic, microcode, etc.), software (e.g., instructions run on a processing device), or a combination thereof. In one implementation, the method 700 is performed by the cluster management system 300 of FIG. 3, or any combination of one or more of its components, as described above.

In some example embodiments, the cluster manager manages a plurality of replica groups, with each replica group comprising a corresponding one of the server machines and at least one replica machine. The replica machine(s) comprise the corresponding shard of data of the corresponding server machine of the corresponding replica group. At operation 710, the cluster manager detects an update of one or more of the server machines in a replica group. At operation 720, in response to the detection of the update of the corresponding shard of one of the server machines, the cluster manager causes the update service to perform a corresponding update to the replica machine(s) in the corresponding replica group of the server machine(s) for which the update was detected.

It is contemplated that any of the other features described within the present disclosure can be incorporated into method 700.

FIG. 8 is a flowchart illustrating a method 800 of cluster management, in accordance with some example embodiments. Method 800 can be performed by processing logic that can comprise hardware (e.g., circuitry, dedicated logic, programmable logic, microcode, etc.), software (e.g., instructions run on a processing device), or a combination thereof. In one implementation, the method 800 is performed by the cluster management system 300 of FIG. 3, or any combination of one or more of its components, as described above.

At operation 810, the cluster manager detects one of the server machines that is unable to satisfy a predetermined threshold condition of a function. At operation 820, the cluster manager selects a replacement server from amongst a plurality of replacement servers based on a determination that the selected replacement server satisfies at least one predetermined constraint. At operation 830, the cluster manager replaces the detected server machine with the selected replacement machine.

It is contemplated that any of the other features described within the present disclosure can be incorporated into method 800.

More detailed examples of implementing the features of the present disclosure are provided below. It is contemplated that other implementation configurations are also within the scope of the present disclosure.

The computer system of the present disclosure can be built on top of Ttorrent (an open source Java bit torrent implementation) to facilitate easy replication of files across many machines. These files can be small configuration files or large index files. The computer system can be used to distribute an experimental ranking model to all search nodes to be used for a new experiment. Again, as new search node replicas come into existence, these ranking models can be made available at these new replicas with minimal additional configuration. A service that wants to use the features of the present disclosure can create a session with which all replication operations are performed.

The computer system can use Bit Torrent as its transport mechanism. Bit Torrent is a file transfer protocol that allows files to be downloaded from multiple servers that have the file. Essentially, portions of the file can be obtained from different servers and these portions are then assembled together on the client. The protocol can be implemented using two kinds of services—a Tracker and a Torrent Peer.

Trackers are processes that run at known locations and Torrent Peers are processes that know how to upload and download files. There can be a separate Torrent Peer for each file (on each machine). Torrent Peers coordinate with each other via the Tracker. When a Torrent Peer wants to download a file, it contacts the Tracker which in turn provides it with a list of other Torrent Peers (on other machines) that have the file. The Torrent Peers then communicate directly with each other to transfer the file.

The sessions can be capable of running Trackers. They can coordinate via an instance to elect the session that will actually run the Tracker.

The following is an example set of operations that can be performed by the computer system, and its components, of the present disclosure. One operation comprises initializing a session by providing an instance and a directory within which the system maintains all the files and metadata.

Another operation comprises creating a replica group by providing its name. Newly created replica groups have no files. The replica group is registered with the instance. Sessions on this instance (on any machine) can now join this replica group.

Yet another operation comprises joining a replica group that already exists. This causes all files/directories that are part of this replica group to be downloaded (if they have not already been downloaded earlier).

Yet another operation comprises adding a single file or a directory (containing nested files and other directories) to a replica group. This file or directory must already be present on the corresponding machine. The file/directory is copied into the directory, and then replicated to all other members of this replica group (services that have already joined the replica group).

Yet another operation comprises removing a file/directory that was previously added to the replica group from a replica group. This causes the file/directory to be removed from all other members of this replica group also.

Yet another operation comprises leaving a replica group that this service previously joined. The files/directories corresponding to this replica group on this machine can be deleted if desired. The files/directories on other members of this replica group are not impacted. The replica group remains intact (except that it loses a member).

Yet another operation comprises deleting a replica group along with all its files and directories. All currently active instances will also delete any files they have from this replica group (and leave the deleted replica group).

A replica group can comprise an abstraction maintained in an instance that contains within it metadata describing a set of files and directories. Concrete instances of replica groups can be present on member machines. These concrete instances also contain the actual files and directories (in addition to the metadata). If, for whatever reason, a concrete instance does not have a particular file or directory, it can obtain it from other concrete instances via Bit Torrent. Concrete instances of a replica group can be created by sessions joining the replica group. The concrete instances have a directory corresponding to the replica group and contains within it all the actual files and (sub) directories of the replica group. If a concrete instance does not have a particular file or directory, it can obtain it from the other concrete instances via Bit Torrent.

When a session is initialized, it is provided a directory in which the session stores all replica group files and other metadata. The top level directory can comprise a sub-directory corresponding to each replica group that has been created/joined, but not yet left/deleted. The directory names can be the same as the replica group names.

The data directory contains the actual files and directories of the replica group. These files can be used directly from this location (in read-only mode), but can be deleted by this or other sessions.

A tombstones directory can contain empty tombstone files corresponding to each file or directory that has been removed (deleted) from the replica group. The staging directory is usually empty. It is used while adding files or directories to the replica group. To perform this operation, the file/directory is first copied or moved to the staging directory. The session then builds the required metadata for this file/directory and moves the file from the staging directory to the data directory. The file and the directory contain metadata.

While the features of the present disclosure do offer APIs to delete files on leaving replica groups, there are many times when it makes sense to leave replica groups without deleting files (e.g., joining the same replica group again shortly). It is also possible that the session crashes—either due to a bug, or due to some other problem on the machine.

These are examples of situations where files may be left around and not used any more.

One mechanism is provided to assist in deleting such files. When a replica group is created, you can specify a period of inactivity after which you consider a concrete instance of a replica group (on a machine) to be garbage.

Sessions periodically scan all of their replica groups and automatically delete their files if they have exceeded their period of inactivity.

The cluster manager 430 can provide an index distribution service, which can comprise a replicated service that can act as a bridge from a software framework for distributed storage and distributed processing of big data on clusters of commodity hardware (a distributed file system) to upload any arbitrary dataset which can then be accessed by service running in production. Each dataset uploaded to this service can be replicated on separate physical machines to ensure its availability.

Once the data is available, clients can “listen” to new datasets by joining the replica group related to the dataset. In some example embodiments, in order to interact with the system, the client can create a configuration file describing their dataset, generate a dataset, and have clients join the replica group mentioned on the configuration. Given a configuration file, the service can figure out what data is available on the distributed file system, copy data to a local temporary directory, map files to partitions, and publish the files to replica groups.

In the configuration file, each node on the index distribution service can require to have the definition of the datasets that it needs to host. Hosts that need to consume the dataset can just join the related replica group.

The replica groups names can be created according to the following expression:

{dataset.name}-{dataset.instance.version}-{dataset.instance.partition}

Other configurations are also within the scope of the present disclosure.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

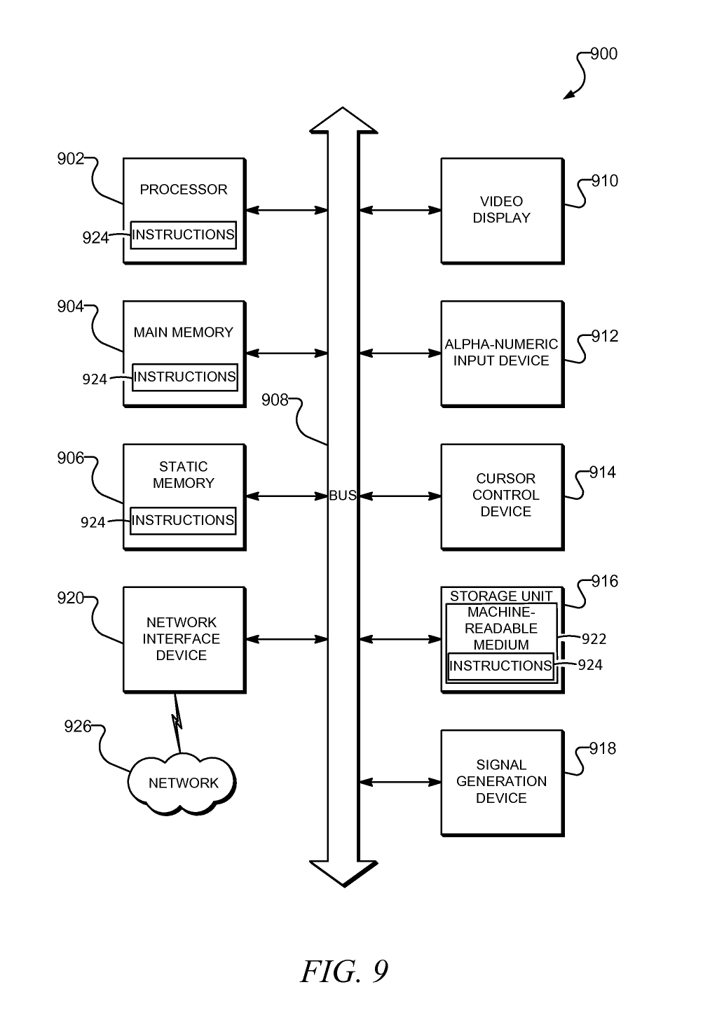

FIG. 9 is a block diagram of an example computer system 900 on which methodologies described herein may be executed, in accordance with some example embodiments. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard or a touch-sensitive display screen), a user interface (UI) navigation device 914 (e.g., a mouse), a disk drive unit 916, a signal generation device 918 (e.g., a speaker) and a network interface device 920.

### Machine-Readable Medium

The disk drive unit 916 includes a machine-readable medium 922 on which is stored one or more sets of instructions and data structures (e.g., software) 924 embodying or utilized by any one or more of the methodologies or functions described herein. The instructions 924 may also reside, completely or at least partially, within the main memory 904 and/or within the processor 902 during execution thereof by the computer system 900, the main memory 904 and the processor 902 also constituting machine-readable media.

While the machine-readable medium 922 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 924 may further be transmitted or received over a communications network 926 using a transmission medium. The instructions 924 may be transmitted using the network interface device 920 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
determining, by a cluster manager implemented by at least one processor, a configuration of roles for a plurality of distinct server machines and for a plurality of builder machines, each one of the server machines storing a corresponding shard of data, and each one of the plurality of builder machines comprising a corresponding one of the corresponding shards of data of the server machines;
applying, by the cluster manager, the configuration of roles to the plurality of server machines, the plurality of builder machines, and an aggregator, the configuration of the builder machines being characterized by an absence of communication with the aggregator;
receiving, by the aggregator, a client request to perform an online service;
transmitting, by the aggregator, a service request to each one of the plurality of server machines based on the client request;
receiving, by each one of the server machines, the service request, each one of the server machines storing a corresponding shard of data;
accessing, by each one of the server machines, the corresponding shard of data;
transmitting, by each one of the server machines, a corresponding response to the aggregator based on the accessing the corresponding shard of data;
receiving, by an update service, update data;
updating, by the update service, the corresponding shard of data of at least one of the server machines based on the update data and the configuration of roles; and
updating, by the update service, the corresponding shard of data of at least one of the builder machines based on the update data and the configuration of roles.

2. The method of claim 1, wherein the online service comprises a search function.

3. The method of claim 1, wherein further comprising the cluster manager managing a plurality of replica groups, each replica group comprising a corresponding one of the server machines and at least one replica machine, the at least one replica machine comprising the corresponding shard of data of the corresponding server machine of the corresponding replica group, wherein the managing comprises, in response to an update of the corresponding shard of one of the server machines, causing the update service to perform a corresponding update to the at least one replica machine in the corresponding replica group of the one of the server machines.

4. The method of claim 1, further comprising:
detecting, by the cluster manager, one of the server machines that is unable to satisfy a predetermined threshold condition of a function;
selecting, by the cluster manager, a replacement server from amongst a plurality of replacement servers based on a determination that the selected replacement server satisfies at least one predetermined constraint; and
replacing, by the cluster manager, the detected server machine with the selected replacement machine.

5. The method of claim 1, wherein the shards of data of the server machines comprise ranking model files of a search index.

6. The method of claim 1, wherein the shards of data of the server machines comprise language model files for a query rewriter.

7. The method of claim 1, wherein the server machines are incorporated into an online social networking service.

8. A system comprising:
a memory; and
at least one processor configured to perform operations comprising:
determining, by a cluster manager, a configuration of roles for a plurality of distinct server machines and for a plurality of builder machines, each one of the server machines storing a corresponding shard of data, and each one of the plurality of builder machines comprising a corresponding one of the corresponding shards of data of the server machines;
applying, by the cluster manager, the configuration of roles to the plurality of server machines, the plurality of builder machines, and an aggregator, the configuration of the builder machines being characterized by an absence of communication with the aggregator;
receiving, by the aggregator, a client request to perform an online service;
transmitting, by the aggregator, a service request to each one of the plurality of server machines based on the client request;
receiving, by each one of the server machines, the service request, each one of the server machines storing a corresponding shard of data;
accessing, by each one of the server machines, the corresponding shard of data;
transmitting, by each one of the server machines, a corresponding response to the aggregator based on the accessing the corresponding shard of data;
receiving, by an update service, update data;
updating, by the update service, the corresponding shard of data of at least one of the server machines based on the update data and the configuration of roles; and
updating, by the update service, the corresponding shard of data of at least one of the builder machines based on the update data and the configuration of roles.

9. The system of claim 8, wherein the online service comprises a search function.

10. The system of claim 8, wherein the operations further comprise the cluster manager managing a plurality of replica groups, each replica group comprising a corresponding one of the server machines and at least one replica machine, the at least one replica machine comprising the corresponding shard of data of the corresponding server machine of the corresponding replica group, wherein the managing comprises, in response to an update of the corresponding shard of one of the server machines, causing the update service to perform a corresponding update to the at least one replica machine in the corresponding replica group of the one of the server machines.

11. The system of claim 8, wherein the operations further comprise:
detecting, by the cluster manager, one of the server machines that is unable to satisfy a predetermined threshold condition of a function;
selecting, by the cluster manager, a replacement server from amongst a plurality of replacement servers based on a determination that the selected replacement server satisfies at least one predetermined constraint; and
replacing, by the cluster manager, the detected server machine with the selected replacement machine.

12. The system of claim 8, wherein the shards of data of the server machines comprise ranking model files of a search index.

13. The system of claim 8, wherein the shards of data of the server machines comprise language model files for a query rewriter.

14. The system of claim 8, wherein the server machines are incorporated into an online social networking service.

15. A non-transitory machine-readable storage medium embodying a set of instructions that, when executed by a processor, cause the processor to perform operations comprising:
determining, by a cluster manager, a configuration of roles for a plurality of distinct server machines and for a plurality of builder machines, each one of the server machines storing a corresponding shard of data, and each one of the plurality of builder machines comprising a corresponding one of the corresponding shards of data of the server machines;
applying, by the cluster manager, the configuration of roles to the plurality of server machines, the plurality of builder machines, and an aggregator, the configuration of the builder machines being characterized by an absence of communication with the aggregator;
receiving, by the aggregator, a client request to perform an online service;
transmitting, by the aggregator, a service request to each one of the plurality of server machines based on the client request;
receiving, by each one of the server machines, the service request, each one of the server machines storing a corresponding shard of data;
accessing, by each one of the server machines, the corresponding shard of data; transmitting, by each one of the server machines, a corresponding response to the aggregator based on the accessing the corresponding shard of data;
receiving, by an update service, update data;
updating, by the update service, the corresponding shard of data of at least one of the server machines based on the update data and the configuration of roles; and
updating, by the update service, the corresponding shard of data of at least one of the builder machines based on the update data and the configuration of roles.

16. The storage medium of claim 15, wherein the online service comprises a search function.

17. The storage medium of claim 15, wherein the operations further comprise the cluster manager managing a plurality of replica groups, each replica group comprising a corresponding one of the server machines and at least one replica machine, the at least one replica machine comprising the corresponding shard of data of the corresponding server machine of the corresponding replica group, wherein the managing comprises, in response to an update of the corresponding shard of one of the server machines, causing the update service to perform a corresponding update to the at least one replica machine in the corresponding replica group of the one of the server machines.

18. The storage medium of claim 15, wherein the operations further comprise:
detecting, by the cluster manager, one of the server machines that is unable to satisfy a predetermined threshold condition of a function;
selecting, by the cluster manager, a replacement server from amongst a plurality of replacement servers based on a determination that the selected replacement server satisfies at least one predetermined constraint; and
replacing, by the cluster manager, the detected server machine with the selected replacement machine.

19. The storage medium of claim 15, wherein the shards of data of the server machines comprise ranking model files of a search index.

20. The storage medium of claim 15, wherein the shards of data of the server machines comprise language model files for a query rewriter.
